(19) United States
(12) Patent Application Publication
(10) Pub. No.: US 2021/0278912 A1
(43) Pub. Date: Sep. 9, 2021

(54) Disposable Capacitive Touchscreen Stylus

(71) Applicant: Swipe Safe, Inc., St. Paul, MN (US)

(72) Inventors: Adam Matthew Gettings, Northfield, MN (US); Yi Zheng, Palo Alto, CA (US)

(73) Assignee: Swipe Safe, Inc., St. Paul, MN (US)

(21) Appl. No.: 17/184,574

(22) Filed: Feb. 24, 2021

Related U.S. Application Data
(60) Provisional application No. 62/985,140, filed on Mar. 4, 2020.

(51) Int. Cl. G06F 3/0354

(52) U.S. Cl. CPC G06F 3/03545; G06F 3/02

(57) ABSTRACT

A disposable stylus is described. The stylus may include a stem having a grip region and an end having a tip. This stylus may include a conductive path between the grip region and the tip having an electrical conductivity that is greater than a predefined amount. During use, a user may grasp or hold the grip region of the stylus. Then, while maintaining contact with the stylus, the user may touch or contact a surface of, e.g., a touch-sensitive display at a contact point using the tip. The stylus may form a conductive path between the user's fingers and the surface. This conductive path may allow the user to transfer or redistribute electric charge to or in the touch-sensitive display, so that a location of the contact point may be determined by the touch-sensitive display while protecting the user from pathogens on or associated with the surface.

### CROSS-REFERENCE TO RELATED APPLICATION

This application claims priority under 35 U.S.C. 119(e) to U.S. Provisional Application No. 62/985,140, entitled “Disposable Capacitive Touchscreen Stylus,” by Adam Matthew Gettings, filed Mar. 4, 2020, the contents of which are hereby incorporated by reference.

### FIELD

The described embodiments relate to a disposable stylus. Notably, the described embodiments relate to a conductive disposable stylus for use with a touch-sensitive display or a touchscreen, such as a capacitive touchscreen.

### BACKGROUND

Because of their ease of use, touch-sensitive displays (which are sometimes referred to as ‘touchscreens’) have been widely adopted as user-interface devices. A touchscreen is an electronic visual display capable of detecting and locating one or more touch points or points of contact with, e.g., a user's finger(s) or hand(s) over a display area.

Many touchscreens are based on resistive, capacitive, infrared or surface acoustic wave detection techniques. For example, a capacitive touchscreen may include an insulator (such as glass) that stores electric charge and one or more transparent conducting layers (such as indium tin oxide). When a conductor (such as the user's finger) touches the touchscreen, a dynamic capacitance between the user's finger and the one or more transparent conducting layers results in an electric field that changes an amount of charge at a touch or contact point.

However, because many touchscreens are based on physical contact with a conductor, such as a users' finger(s) or hand(s), these touchscreens can facilitate the transmission of pathogens, such as bacteria and viruses. For example, check-in terminals at airports often use touchscreens. While many travelers are concerned about the cleanliness of aircraft interiors, because a large number of people come in contact with the touchscreens in check-in terminals, the surfaces of these touchscreens are typically coated with more bacteria and viruses than are found in aircraft restrooms. The increased risk of disease transmission associated with touchscreens is a deterrent to the use of this technology and can adversely impact associated businesses.

### SUMMARY

A stylus for use with a touch-sensitive display is described. This stylus includes a stem having a grip region and an end having a tip. The stylus includes a conductive path between the grip region and the tip having an electrical conductivity that is greater than a predefined amount, such as 10⁻¹³ S/m. Alternatively or additionally, the tip may have a surface resistance that is less than 10²Ω and the stem may have a surface resistance that is less than 10⁴Ω. Moreover, the tip may have a Shore hardness between Shore 00-0 and Shore D-0, and the stem may have a Shore hardness between Shore 00-90 and Shore D-100.

Note that the stylus may include a material that includes conductive fibers that provide the conductive path. Alternatively or additionally, at least a portion of the stylus may include a conductive coating.

In some embodiments, the stylus is included in a package. This package may include one or more additional instances of the stylus.

Another embodiment provides the package with the stylus.

Another embodiment provides a method for providing instructions. During the method, a disposable stylus is provided. Then, the instructions for the use of the stylus are provided or displayed (e.g., on a display or printed on paper). The instructions may indicate that a user grasp the stylus at the grip region and touch the tip to a surface of a touch-sensitive display or a button. For example, the stylus may be provided from a dispenser and the instructions may be displayed on an adjacent display, a poster and/or a printed handout. In some embodiments, the stylus and the instructions are included in a package.

Another embodiment provides the display.

Another embodiment provides an electronic device that includes the display.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a drawing illustrating an example of a stylus in accordance with an embodiment of the present disclosure.

FIG. 2 is a drawing illustrating an example of use of the stylus of FIG. 1 in accordance with an embodiment of the present disclosure.

FIG. 3 is a flow diagram illustrating an example of a method for providing instructions in accordance with an embodiment of the present disclosure.

FIG. 4 is a block diagram illustrating an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

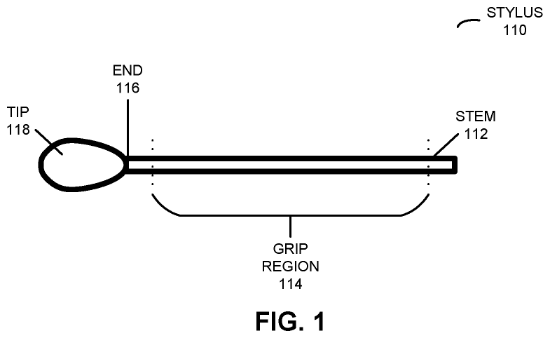

A stylus for use with a touch-sensitive display (such as a touch-sensitive display or touchscreen based on a capacitive detection technique) is described. An example of stylus 110 is shown in FIG. 1. Stylus 100 may include a stem 112 having a grip region 114 and an end 116 having a tip 118. Stylus 100 may include a conductive path between grip region 114 and tip 118 having an electrical conductivity that is greater than a predefined amount, such as 10⁻¹³ S/m.

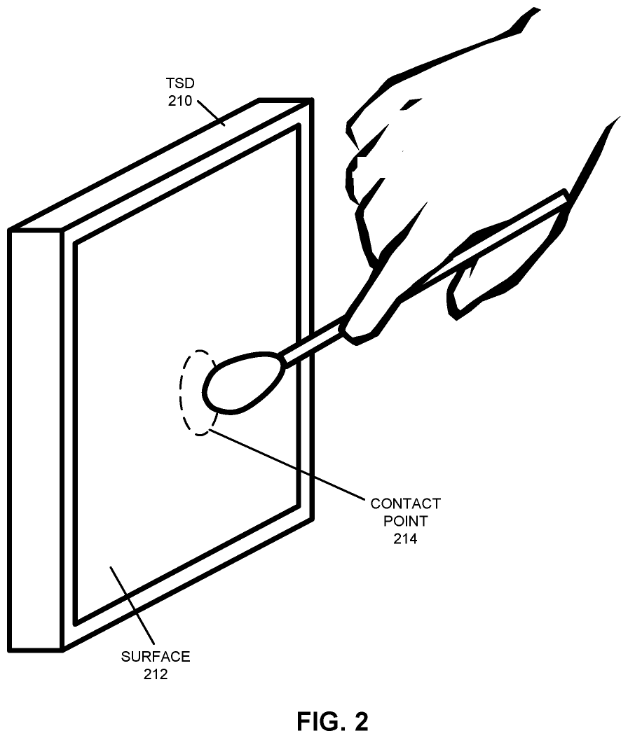

As shown in FIG. 2, which presents a drawing illustrating an example of use of stylus 110, a user may grasp or hold grip region 114 of stylus 110. Then, while maintaining contact with stylus 110, the user may touch or contact a surface 212 of touch-sensitive display (TSD) 210 at a contact point 214 using tip 118 of stylus 110. Stylus 110 may form a conductive path between the user's fingers and surface 212. This conductive path may allow the user to transfer or redistribute electric charge to or in touch-sensitive display 210, so that a location of contact point 214 may be determined by touch-sensitive display 210.

Moreover, using stylus 110, the user may be able to electronically interact with touch-sensitive display 210 without making direct physical contact with surface2 212. Consequently, the user may be able to activate a virtual icon in a user interface displayed on touch-sensitive 210 display by indirectly and selectively contacting surface 212 using stylus 110. For example, the user may touch tip 118 on surface 212 within a strike area of the virtual icon and then may break contact between tip 118 and surface 212.

However, because the user does not directly physically contact surface 212, the user is less likely to come in contact with any pathogens on or associated with surface 212, such as bacteria or viruses. Therefore, stylus 110 may reduce the transmission of disease-causing agents or vectors when the user interacts with or uses touch-sensitive display 210.

When the user is finished using stylus 110, the user may discard, compost or recycle stylus 110. Consequently, in some embodiments, stylus 110 may be disposable. Alternatively, when the user is finished using stylus 110, the user may clean stylus 110, such as using an alcohol-based cleaning solution or using bleach.

In some embodiments, stylus 110 is fabricated from paper and/or cotton. For example, the stem may be fabricated from paper and the tip may be fabricated from cotton. Moreover, the paper and/or the cotton may be infused or may include conductive material, such as conductive fibers (e.g., graphite, carbon or metal wire) that provide the conductive path. Alternatively, the paper and/or the cotton may include a conductive coating. However, a wide variety of materials may be used to fabricate at least portions of stylus 110, include: a plastic, polyurethane, polyester, polyethylene (such as low or high-density polyethylene), ethylene-vinyl acetate, an organic material, conductive carbon, an inorganic material, paper, cotton, cloth, resin, metal (such as a paper clip), a polymer, an elastomer, wood, bamboo, cardboard, and/or a composite material. In general, stylus 110 may include a conductive stick or stem with a soft, conductive end effector or tip.

Note that stem 112 may have a Shore hardness between Shore 00-90 and Shore D-100. Moreover, stem 112 may have a surface resistance under 10³ to 10⁶Ω, such as under 10⁴Ω. While some material may have sufficient electrical conductivity (or a low enough surface resistance), others may require a conductive coating. This conductive coating may be applied using: electroplating, conductive painting, etc. Alternatively, the conductive coating may include a metal foil or wire. In some embodiments, stem 112 may be a conductive elastomer, but may have a sufficient hardness to be firm and able to push or depress a button.

Tip 118 may not scratch a glass touchscreen and may be conductive. For example, tip 118 may have a Shore hardness between Shore 00-0 and Shore D-0. Tip 118 may be fabricated from conductive carbon or metal infused foam, such as: anti-static foam, electrostatic discharge foam, a conductive rubber (such as a filled silicone elastomer), and/or a cloth fabric containing metal wire (e.g., copper, brass, gold, silver, aluminum, steel or stainless steel). When compressed with a force of about 5-10 Newtons, tip 118 may flatten on a surface of touch-sensitive display 210 to an area of at least 4 mm², which is sufficient to activate a touchscreen based on a capacitive detection technique. Tip 118 may have a surface resistance of 10⁻⁸ to 10³Ω, such as 10²Ω. However, depending on the electrical conductivity of stem 112, in some embodiments, tip 118 may have a surface resistance of up to 10⁵Ω.

Note that stem 112 may be joined permanently or temporarily to tip 118 using electrically conductive epoxy or an adhesive (such as a glue).

In some embodiments, a lower electrical conductivity stem 112 is used in conjunction with a higher electrical conductivity tip 118, or vice versa. In general, there may be a balance in the conductive properties of components in stylus 110, so that the conductive path has sufficient electrical conductivity for use with a touch-sensitive display based on a capacitive detection technique. Stylus 210 may have an electrical conductivity between 10⁻¹³ S/m to 10⁷ S/m.

For example, stylus 110 may be about the size of a toothpick or Q-tip or the size of a crayon or a pen. Notably, stylus 110 may have a thickness between 2 and 10 mm, a length between 25 and 200 mm, and may be round, square or may have another cross-sectional profile. Tip 118 may have a variety of shapes and colors, which may or may not indicate differences in a physical property, such as electrical conductivity, compliance or sensitivity when used with touch-sensitive display 210. For example, a shape and/or color of stylus 110 may indicate that is suitable for use with or compatible with a particular touch-sensitive display, type of touch-sensitive display and/or brand of touch-sensitive display.

Furthermore, in some embodiments, stylus 110 is individually wrapped in packaging (such as a plastic or aluminum-coated plastic pouch or bag) or is include with multiple instances of stylus 110 in a bulk bag or package. Note that the packaging may open up to form a small holder than can sit on a shelf or a table. The packaging may have a peel-and-stick backing, so that it could attach to the side of a vertical surface. Alternatively or additionally, the packaging may have a hook to hang on retail shelves and/or at a location of use, or a receptacle to remateably or removably couple to a hook. Additionally, the packaging may be portable, so that it fits in a user's pocket or purse. In some embodiments, stylus 110 is dispensed from a machine similar to a tooth-pick dispenser.

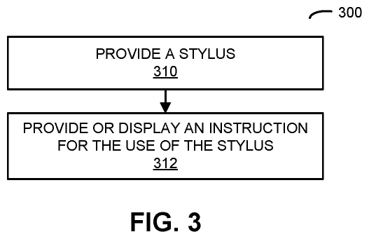

FIG. 3 presents a flow diagram illustrating an example of a method 300 for providing instructions in accordance with an embodiment of the present disclosure. During the method, a disposable stylus is provided (operation 310). Then, the instructions for the use of the stylus are provided or displayed (operation 312), e.g., on a display or printed on paper. The instructions may indicate that a user grasp the stylus at a grip region and touch a tip of the stylus to a surface of a touch-sensitive display or a button.

For example, the stylus may be provided from a dispenser and the instructions may be displayed on an adjacent display, a poster and/or a printed handout. In some embodiments, the stylus and the instructions are included in a package.

In some embodiments of method 300, there may be additional or fewer operations. Moreover, there may be different operations. Furthermore, the order of the operations may be changed, and/or two or more operations may be combined into a single operation.

Referring back to FIG. 1, while the preceding discussion illustrated the use of stylus 110 with a capacitive touch-sensitive display, stylus 110 may be used with a wide variety of touch-sensitive displays and, more generally, with a variety of human-interface devices, such as: a touch-sensitive display based on a resistive detection technique, a touch-sensitive display based on an infrared detection technique, a touch-sensitive display based on a surface acoustic wave detection technique, a keyboard, a button, a track pad, etc.

For example, stylus 110 may be used in conjunction with: a public button, a cash register, a medical device, an elevator, a door opener, an intercom, a door of a train or a bus, an electronic device (such as a display, a television, a cellular telephone, a portable electronic device, a radio, a vending machine, etc.), and/or a public touchscreen (such as a touchscreen in a taxicab, an automatic teller machine, a ticket terminal, a cash register, a vending machine, a touchscreen in an automobile, a thermostat, an alarm system, exercise equipment, etc.).

While the preceding embodiments were illustrated with particular configurations, in other embodiments the stylus may include fewer or additional components, different components, two or more components may be combined into a single component, and/or a position of at least one component may be changed. For example, in some embodiments, stylus 110 may include instances of tip 118 at both ends of stem 112.

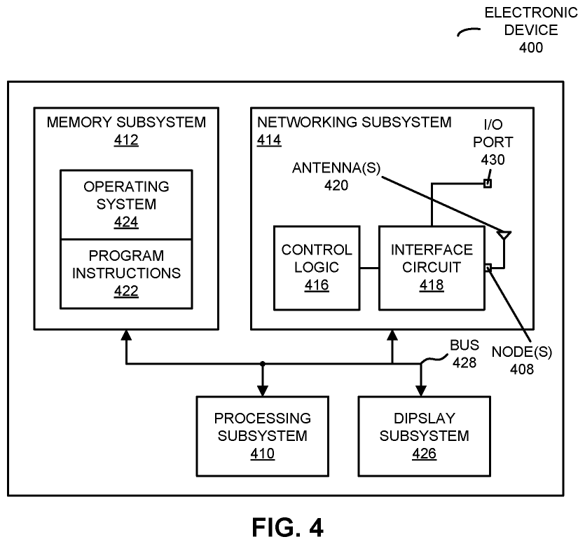

We now describe a display or an electronic device that may be used to present an instruction related to the use of the stylus. FIG. 4 presents a block diagram illustrating an electronic device 400. This electronic device includes processing subsystem 410, memory subsystem 412, and networking subsystem 414. Processing subsystem 410 includes one or more devices configured to perform computational operations. For example, processing subsystem 410 can include one or more microprocessors, one or more application-specific integrated circuits (ASICs), one or more microcontrollers, one or more programmable-logic devices, one or more graphics processing units (GPUs) and/or one or more digital signal processors (DSPs).

Memory subsystem 412 includes one or more devices for storing data and/or instructions for processing subsystem 410 and networking subsystem 414. For example, memory subsystem 412 can include dynamic random access memory (DRAM), static random access memory (SRAM), and/or other types of memory. In some embodiments, instructions for processing subsystem 410 in memory subsystem 412 include: one or more program modules or sets of instructions (such as program instructions 422 or operating system 424), which may be executed by processing subsystem 410. Note that the one or more computer programs may constitute a computer-program mechanism. Moreover, instructions in the various modules in memory subsystem 412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 410.

In addition, memory subsystem 412 can include mechanisms for controlling access to the memory. In some embodiments, memory subsystem 412 includes a memory hierarchy that comprises one or more caches coupled to a memory in electronic device 400. In some of these embodiments, one or more of the caches is located in processing subsystem 410.

In some embodiments, memory subsystem 412 is coupled to one or more high-capacity mass-storage devices (not shown). For example, memory subsystem 412 can be coupled to a magnetic or optical drive, a solid-state drive, or another type of mass-storage device. In these embodiments, memory subsystem 412 can be used by electronic device 400 as fast-access storage for often-used data, while the mass-storage device is used to store less frequently used data.

Networking subsystem 414 includes one or more devices configured to couple to and communicate on a wired and/or wireless network (i.e., to perform network operations), including: control logic 416, an interface circuit 418, one or more antennas 420 and/or input/output (I/O) port 430. (While FIG. 4 includes one or more antennas 420, in some embodiments electronic device 400 includes one or more nodes 408, e.g., a pad or a connector, which can be coupled to one or more antennas 420. Thus, electronic device 400 may or may not include one or more antennas 420.) For example, networking subsystem 414 can include a Bluetooth networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 400 may use the mechanisms in networking subsystem 414 for performing simple wireless communication between the electronic devices, e.g., transmitting advertising or beacon frames and/or scanning for advertising frames transmitted by other electronic devices.

Within electronic device 400, processing subsystem 410, memory subsystem 412, and networking subsystem 414 are coupled together using bus 428. Bus 428 may include an electrical, optical, and/or electro-optical connection that the subsystems can use to communicate commands and data among one another. Although only one bus 428 is shown for clarity, different embodiments can include a different number or configuration of electrical, optical, and/or electro-optical connections among the subsystems.

In some embodiments, electronic device 400 includes a display subsystem 426 that provides or presents information (such as an instruction related to the use of a conductive stylus) to a user of electronic device 400. For example, display subsystem 426 may include a display that displays the information, which may include a display driver and the display, such as a liquid-crystal display, a multi-touch touchscreen, etc.

Electronic device 400 can be (or can be included in) any electronic device with at least one network interface. For example, electronic device 400 can be (or can be included in): a desktop computer, a laptop computer, a subnotebook/netbook, a server, a mainframe computer, a cloud-based computer system, a tablet computer, a smartphone, a cellular telephone, a smart watch, a headset, electronic or digital glasses, headphones, a consumer-electronic device, a portable computing device, an access point, a router, a switch, communication equipment, test equipment, a wearable device or appliance, and/or another electronic device.

Although specific components are used to describe electronic device 400, in alternative embodiments, different components and/or subsystems may be present in electronic device 400. For example, electronic device 400 may include one or more additional processing subsystems, memory subsystems, networking subsystems, and/or feedback subsystems (such as an audio subsystem). Additionally, one or more of the subsystems may not be present in electronic device 400. Moreover, in some embodiments, electronic device 400 may include one or more additional subsystems that are not shown in FIG. 4. Also, although separate subsystems are shown in FIG. 4, in some embodiments, some or all of a given subsystem or component can be integrated into one or more of the other subsystems or component(s) in electronic device 400. For example, in some embodiments program instructions 422 are included in operating system 424.

Moreover, the circuits and components in electronic device 400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 414, such as a radio. Moreover, the integrated circuit may include hardware and/or software mechanisms that are used for transmitting wireless signals from electronic device 400 and receiving signals at electronic device 400 from other electronic devices. Aside from the mechanisms herein described, radios are generally known in the art and hence are not described in detail. In general, networking subsystem 414 and/or the integrated circuit can include any number of radios. Note that the radios in multiple-radio embodiments function in a similar way to the single-radio embodiments.

In some embodiments, networking subsystem 414 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, receiving the input data, etc.)

While communication protocols compatible with Ethernet, Wi-Fi and a cellular-telephone communication protocol may be used, the described embodiments of the user-interface techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the user-interface techniques may be implemented using program instructions 422, operating system 424 (such as a driver for interface circuit 418) and/or in firmware in interface circuit 418. Alternatively or additionally, at least some of the operations in the user-interface techniques may be implemented in a physical layer, such as hardware in interface circuit 418.

In the preceding description, we refer to ‘some embodiments.’ Note that ‘some embodiments’ describes a subset of all of the possible embodiments, but does not always specify the same subset of embodiments. Moreover, note that the numerical values provided are intended as illustrations of the user-interface techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A stylus, comprising:
a stem having a grip region and an end having a tip, wherein the stylus comprises a conductive path between the grip region and the tip,
wherein the tip has a surface resistance less than 10²Ω and the stem has a surface resistance less than 10⁴Ω, or a conductive path between the grip region and the tip having an electrical conductivity greater than 10⁻¹³ S/m, and
wherein the stylus is disposable.

2. The stylus of claim 1, wherein the stylus is configured for use with a touch-sensitive display based on a capacitive detection technique.

3. The stylus of claim 1, wherein the stylus is configured for use with a physical button.

4. The stylus of claim 1, wherein the stylus is configured for use with a human-interface device.

5. The stylus of claim 1, wherein the tip has a Shore hardness between Shore 00-0 and Shore D-0.

6. The stylus of claim 1, wherein the stem has a Shore hardness between Shore 00-90 and Shore D-100.

7. The stylus of claim 1, wherein the stylus comprises a material including conductive fibers that provide the conductive path.

8. The stylus of claim 1, wherein at least a portion of the stylus includes a conductive coating.

9. A package, comprising:
a housing surrounding a stylus, wherein the stylus comprises:
a stem having a grip region and an end having a tip, wherein the stylus comprises a conductive path between the grip region and the tip,
wherein the tip has a surface resistance less than 10²Ω and the stem has a surface resistance less than 10⁴Ω, or a conductive path between the grip region and the tip having an electrical conductivity greater than 10⁻¹³ S/m, and
wherein the stylus is disposable.

10. The package of claim 9, wherein the housing comprises a hook or a receptacle configured to remateably couple to a hook.

11. The package of claim 9, wherein the package comprises multiple instances of the stylus.

12. The package of claim 9, wherein the stylus is configured for use with a touch-sensitive display based on a capacitive detection technique.

13. The package of claim 9, wherein the tip has a Shore hardness between Shore 00-0 and Shore D-0; and
wherein the stem has a Shore hardness between Shore 00-90 and Shore D-100.

14. The package of claim 9, wherein the stylus comprises a material including conductive fibers that provide the conductive path or at least a portion of the stylus includes a conductive coating.

15. A method for providing instructions, comprising:
providing a stylus, wherein the stylus comprises:
a stem having a grip region and an end having a tip, wherein the stylus comprises a conductive path between the grip region and the tip,
wherein the tip has a surface resistance less than 10²Ω and the stem has a surface resistance less than 10⁴Ω, or a conductive path between the grip region and the tip having an electrical conductivity greater than 10⁻¹³ S/m, and
wherein the stylus is disposable; and
providing or displaying instructions for use of the stylus, wherein the instructions indicate that a user grasp the stylus at the grip region and touch the tip to a surface of a touch-sensitive display.

16. The method of claim 15, wherein the touch-sensitive display is based on a capacitive detection technique.

17. The method of claim 15, wherein the tip has a Shore hardness between Shore 00-0 and Shore D-0; and
wherein the stem has a Shore hardness between Shore 00-90 and Shore D-100.

18. The method of claim 15, wherein the stylus comprises a material including conductive fibers that provide the conductive path or at least a portion of the stylus includes a conductive coating.

19. The method of claim 15, wherein the instructions indicate that the stylus is for use with the touch-sensitive display.

20. The method of claim 15, wherein the instructions indicate that the stylus is for use with a physical button.
